(19) United States
(12) Patent Application Publication
(10) Pub. No.: US 2016/0110674 A1
(43) Pub. Date: Apr. 21, 2016

(54) SYSTEM AND METHOD FOR BUSINESS PARTNERSHIP PAIRINGS

(71) Applicant: Gregory Berman, Delray, FL (US)

(72) Inventor: Gregory Berman, Delray, FL (US)

(21) Appl. No.: 14/519,135

(22) Filed: Oct. 21, 2014

(51) Int. Cl. G06Q 10/06

(52) U.S. Cl. CPC G06Q 10/063112; G06Q 10/063114

(57) ABSTRACT

A system and method for matching business interests of investors, business owners, entrepreneurs, other individuals, and/or students for displaying, suggesting, facilitating and/or creating business partnerships based on algorithmic calculation from various user input responses, which may include personality factors, the calculation being executed in a non-transitory tangible medium.

### FIELD OF THE INVENTION

The present invention relates to matching business partners, and more in particularly to a system and method for facilitating new business entities and/or existing entities that intelligently matches one or more of investors, business owners, entrepreneurs, service providers, other individuals, and/or students based on combined interests, personalities, and skill sets for increasing the probability of successful business partnerships.

### BACKGROUND OF THE INVENTION

Services generally for introducing persons likely to have a successful personal relation in terms of satisfaction is known. However, little is known for systems and methods for matching one or more of an combination of investors, business owners, entrepreneurs, service providers, other individuals, and/or students. To date, investors, business owners, entrepreneurs, other individuals, and/or students are limited to matching services based exclusively on the merits of the business venture itself, which fail to take into account personal attributes that alter the strength of a particular business venture. Business relationships depend on complex interactions between a large number of variables. Yet in all too many instances, business partnerships flutter or fail because the partners lack fundamental character traits and/or skills. Startup ventures in particular specifically require personality traits and/or skills in particular positions or roles to complement each other to insure a better probability that the business entity will succeed.

Accordingly, there is a need for improving the matching of various users and/or entities having varying business interests, including business partners made up of investors, business owners, entrepreneurs, service providers, other individuals or entities, and/or students.

### SUMMARY OF THE INVENTION

The present invention advantageously provides system and method for matching business interests of investors, business owners, entrepreneurs, other individuals, and/or students.

According to an embodiment of the present invention, a business partner system utilizes a business partner algorithm, the business partner algorithm calculates based on user responses and suggests potential partnership combinations based on a selectable combination of a potential partner's geographic location, common industry interests, complimentary skill-sets, complimentary personalities, and other factors described herein. For example, a first person having an outgoing personality with strong management and sales skills may be paired with a second person having an introverted personality, strong technical and financial skills, thereby producing a team with complementary personalities and business skills likely to increase the probability that the business partnership and/or business entity will succeed.

According to an embodiment of the present invention, a principal object is to provide a system and method for identifying suggested business partners performed in a non-transitory computer readable medium, comprising receiving personality information relating to a plurality of potential business partners, receiving skill set information relating to a plurality of potential business partners, and determining, based on at least one of the personality information and the skill set information, a relative strength of potential business relationship partnership between a first user and a second user.

According to an embodiment of the present invention, another object is to receive business information relating to a plurality of potential business partners, wherein the business information is used in determining the relative strength of potential business relationship partnership between the first user and the second user.

According to an embodiment of the present invention, another object is to receive financial information relating to a plurality of potential business partners, wherein the financial information is used in determining the relative strength of potential business relationship partnership between the first user and the second user.

According to an embodiment of the present invention, another object is to display to a plurality of users at least one potential business partner.

According to an embodiment of the present invention, another object is to associate a greater value between a first user and a second user having coinciding responses to a personality question.

According to an embodiment of the present invention, another object is to associate a greater value between a first user and a second user having differing responses to a personality question.

According to an embodiment of the present invention, another object is to associate a greater value between a first user and a second user having coinciding response(s) to a personality question.

According to an embodiment of the present invention, a principal object is to calculate a business partner relationship strength between a plurality of users performed in a non-transitory computer readable medium comprising calculating a projected business partner strength score between a first user and at least a second user based on user supplied response data for determining a likelihood of a successful business partnership with at least a second user and suggesting to the first user potential business partnerships with at least the second user.

According to an embodiment of the present invention, the response data includes personality response data of the first user and at least the second user.

According to an embodiment of the present invention, another object is to assess an increased business partner strength score resulting from a personality question response of the first user differing with a personality question response of the second user.

According to an embodiment of the present invention, another object is to assess an increased business partner strength score resulting from personality question response(s) of the first user coinciding and/or differing with a personality question response(s) of the second user.

According to an embodiment of the present invention, another object is to facilitate communication between the first user and the second user.

According to an embodiment of the present invention, another object is to calculate the projected business partner strength score based on a plurality of user ratings user supplied responses to a questionnaire.

According to an embodiment of the present invention, another object is to calculate the projected business partner strength score based on success of prior partnerships of at least the second user.

According to an embodiment of the present invention, another object is to display to the first user potential business partnership opportunities with at least the second user having at least one of a corresponding personality response and at least one of a differing personality response.

According to an embodiment of the present invention, a principal object is to match potential business partners performed in a non-transitory computer readable medium comprising receiving information from a first user related to a particular business venture and matching a second user to the particular business venture based on a combination of desired business venture data from the second user, skill set response data from the second user, personality response data from the second user, and financial information data from the second user. In some embodiments, a score, or a weighted score, is applied to one or more answers to user response data to calculate or suggest potential business partners.

According to an embodiment of the present invention, another object is to determine a likelihood of a successful business partnership match based on an associated score/value for the personality response data from the second user and an associated value for the skill set response data from the second user; and then suggesting the second user to the first user as a potential business partner.

Other objects will become evident as the present invention is described in detail below.

### BRIEF DESCRIPTION OF THE DRAWINGS

Embodiments of the present application are described herein in which similar elements are given similar reference characters, and a more complete understanding of the present invention, and the attendant advantages and features thereof, will be more readily understood by reference to the following detailed description when considered in conjunction with the accompanying drawings wherein:

FIG. 1 is a block diagram of an exemplary system in accordance with at least some principles of the present embodiment;

FIG. 2 is a flow chart of an exemplary process for receiving business interest partnership information in accordance with at least some principles of the present embodiment;

FIG. 3 is a flow chart of an exemplary process for connecting one or more partners in accordance with at least some of the principles of the present embodiment; and

FIG. 4 is a flow chart of an exemplary process for connecting one or more partner groups in accordance with at least some of the principles of the present embodiment.

### DETAILED DESCRIPTION OF THE INVENTION

The present invention advantageously provides a system and method for facilitating new business entities and/or existing entities that intelligently matches one or more of investors, business owners, entrepreneurs, service providers, other individuals, and/or students based on combined interests, personalities, and skill sets for increasing the probability of successful business partnerships. The present invention contemplates various types of systems and methods for displaying, suggesting, facilitating and/or creating business partnerships based on algorithmic calculation, regression analysis calculation, statistical modeling calculation, or other calculation, from various user input responses, which may include without limitation personality factors, the calculation being executed in a non-transitory tangible medium.

Accordingly, the system and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In the various embodiments found herein, which can be combined as desired, the system and process may utilize mathematical computer analysis based on various attributes of the plurality of user profiles.

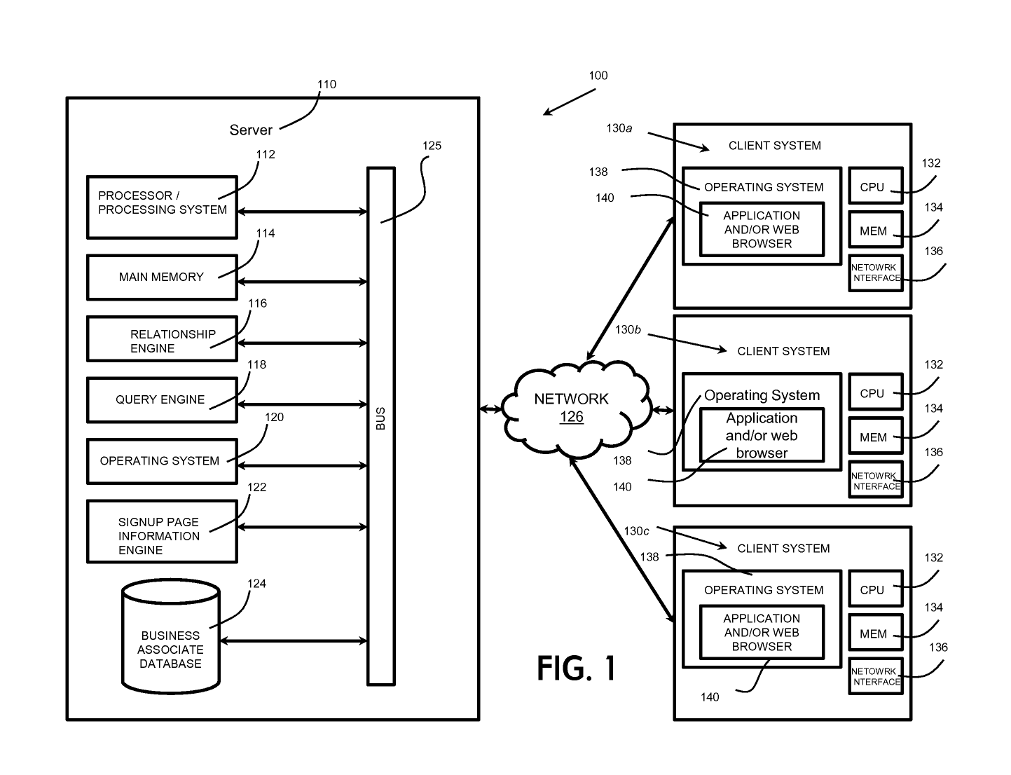

Referring now to the drawings figures in which like reference designators refer to like elements. FIG. 1 shows an exemplary block diagram of an exemplary system in accordance with one or more embodiments. System 100 can include server 110 that can further include various server components, which may be optionally implemented as either software and/or hardware. The server 110 includes without limitation a processor 112 at least for executing instructions, main memory 114 that stores a plurality of data, a relationship engine 116 for calculating business partnership potential optionally based on user supplied response data, a query engine 118 that allows users to perform potential business partner queries, an operating system 120, a signup page 122 information engine for requesting and storing into one or more databases business partnership information data, a business associate database 124, and a bus 125 for facilitating communication between one or more elements of the server 110. The business associate database 124 receives and stores data from client systems 130 entered by users.

The system 100 is connected to a communication network 126. A plurality of client systems 130 each equipped with a CPU 132, a memory 134, and a network interface 136. The client systems 130 each including an operating system 138 for utilizing an application and/or web browser 140. The client systems 130 each communicating with the server 110 via the network 126. In an embodiment, the client systems 130 may include without limitation desktop computers, laptops, tablets, phones including smart phones, and the like.

Users may use a plurality of systems 130a-c to access one or more websites provided by the server 110 over the network 126.

The Server 110 and/or the plurality of client systems 130a-c may include additional, fewer, and/or different components than those listed above without departing from the spirit and scope of the instant invention. The plurality of client system 130 may be formed of an unlimited number of client systems 130n.

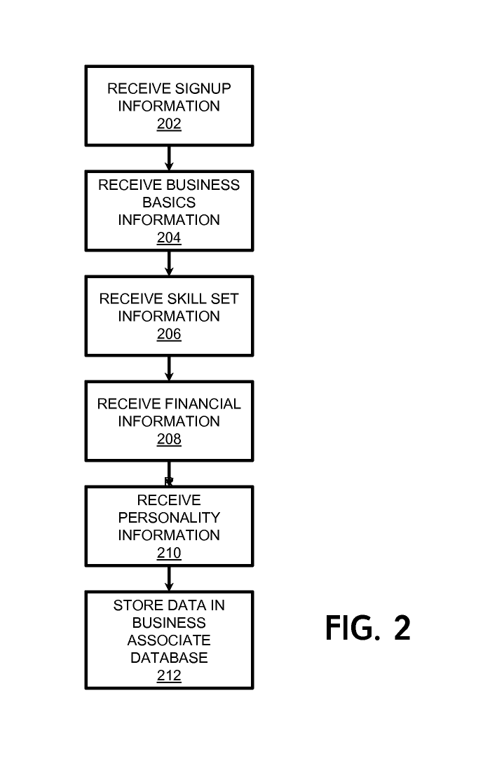

Referring now to FIG. 2, a user accesses one or more websites and receives information from the server 110 or elsewhere. At process block 202, the server 110 receives signup information of persons interested in forming business partnerships and/or relationships. As described below, user input will be used by the Server 110 to calculate or otherwise match users having the potential to form successful business partnerships. The website displays signup information to a user on client system 130. The received information is stored in the business associate database 124. After receiving the signup information, the user may input additional information to be used for business matching purposes. For example, the following information, found in the following table, may be collected via a signup page:

Signup Information

1. First Name
2. Last Name
3. Email
4. Password
5. Type of user selected from one of Business Owner, Entrepreneur,
Investor, Student, Service Provider
6. Geographic Location

Subsequent to signup, the website displays a profile page that may be built and manipulated by the user. The user's profile may include a basic information section, a business information section, a financial information section, and a personality biography section. In an embodiment, a score may be calculated for any or each section, individually or in aggregate in or for each user in comparison to other users for matching the best organic business partnership matches. Optionally, each section or particular user responses for each section may be weighted for calculating or suggesting business partnerships or relationships, such that a particular section may provide a more favorable likelihood of matching two or more users together. For example geographic location, personality response data, or skill sets.

At process block 204, the basic information section may include the same or similar information received from the user during signup. The basic information section may be adjusted or changed following signup. In an embodiment, when a user describes themselves as a business owner and/or entrepreneur, the user may be asked to describe whether they are looking for a business partner, an investor, a strategic alliance, or a combination thereof. In an embodiment, the user may select one or more of each of a business partner, an investor, and a strategic alliance. In an embodiment, the user may select the total number of each desired business partners or number of each desired business partners for each type, for suggesting other users as potential business partnerships. For example, the user may select a suggestions for one partner, two investors, three service providers. In one embodiment, the relationship engine 116 and/or server 110 may use the user's desired partnership type for matching with one or more applicable partner matches of the pool of users stored in the business associate database 124. The basic information section may include a user uploaded picture or alternatively an introductory video. The user may also include location information, such as country, state, and zip code, which may be used for finding the best match in a particular geographic location.

The business information section may allow the user to input business information for display and/or analysis. At process block 206, the business information section allows for the input of one or more specific skill sets, where specific skill sets may be defined as including without limitation sales/marketing skills, financial skills, technical skills, management/leadership skills, which is received by the server 110. A business summary section allows for the entry of a user defined business summary, which may include the concept of the business. Once a match is recommended to the user, the business summary will help other users determine whether the proposed business venture would be of interest. The concept of the business may include what it does, products and/or services offered, and the markets served, which may be utilized by the relationship engine 116 and/or server 110 to analyze and match business partners.

A partner match portion of the business information section allows for selection of desirable partner match characteristics identified by specific skill sets. The partner match portion may additionally include a partner match detail section that allows a user to input an explanation as to what is being sought in a partner.

The business information section may include the date that a user's business was founded. The date that a user's business was founded may be used to assess the strength of a potential partnership and/or likelihood of success of a lasting business partnership, and may be used to calculate a business partnership score as described throughout.

The business information section may include a company development stage for user input of the stage of development of the business. The company development stage may be defined to include research/concept stage, seed/startup stage, first stage, second stage, bridge/mezzanine, IPO/Initial Public Offering, Follow-on/Later Stage, or not applicable. The stage of the business may be used by the server 110 to calculate or otherwise determine and/or suggest whether particular partners are seeking like business relationships at the company development stage.

The business information section may include the legal designation/organizational structure of the business. The legal designation may be defined to include C-Corporation, S-Corporation, Professional Corporation, Limited Liability Company, Non-Profit Company, Sole Proprietorship, Unincorporated, or other corporate designations not mentioned.

In some cases, it may be desirable for a particular user to pair with a business and/or idea affiliated with an educational institute. The business information section may include an option to select whether the business and/or idea is affiliated with one or more educational institutes, universities, and/or endeavors.

The business information section may include the option to provide a particular website address. The website address may be used to allow other users the opportunity to further explore a business opportunity.

The business information section may allow a user to set a salary range offered to another user or a salary range that the user is willing to accept.

The business information section may allow a user to select whether a partner must be willing and/or able to invest into the business venture. In an embodiment, the relationship engine 116 may only match users as potential business partners if one or more of the users is willing to invest into the business venture for which one user is seeking other users as business partners.

The business information section may allow a user to select whether an intern would be considered.

The business information section may allow the user to input business related information, including without limitation the website, office phone number, or other pertinent business information.

At process block 208, the financial information section allows a user to enter information depending on whether that user is or represents investors, business owners, entrepreneurs, other individuals, and/or students, which is received by the server 110. The user entered information, like all user supplied information, may be optionally used to calculate potential business partnerships between users and suggest one or more business partners/users to one or more other users. The requested information may vary depending on previous information that the server 110 has collected and/or received. For example, if the user is, and/or represents the interests of, a business, the user is asked to input one or more of the annual company revenue. Alternatively, if the user is an individual looking for a partnership opportunity, the user may be asked to enter salary requirements, whether the user would consider an internship, and whether the user is willing to personally invest in a potential business opportunity. For another example, if the user is an investor, the user may be asked whether the user prefers equity, debt, or some other arrangement, or indicating that it depends on the deal. Investors may be asked other investment related questions and/or allowed to enter a block of text identifying investment criteria. If the user is a service provider, the user may be asked for annual sales information, explanation of fees, and whether payment plans are offered.

In an embodiment, the user signups as a business owner, in which case, the server 110 may request past revenue of the business for quarter one, quarter two, quarter three, and quarter four for one or more years. Additionally, the financial information section allows the user business owner to select current funding sources. The funding sources may defined as including without limitation self-funded, friends and/or family, angel investors, venture capital, private institution, bank financing or other debt, or not funded. The financial information section allows the user business owner to indicate recent milestones, such as recent contracts, sales, orders, or the like.

In process block 210, the personality biography section may allow the user to input personality information for display and/or analysis, which is received by the server 110. The personality biography section may allow for the input of one or more personality responses. Some of the personality responses may be generated from the exemplary table of questions and a score/value determined for responses with either of a coinciding answer of a differing answer:

Personality Questions

| | Exemplary |
|---|---|
| | matching |
| Exemplary Questions | scheme |
| 1. Would you rather come up with a plan than deal with | Match with |
| its implementation? | same |
| 2. If an idea you believe in doesn't work you easily | Match with |
| move on? | opposite |
| 3. The ends justify the means if the situation calls | Match with |
| for it? | same |
| 4. You are a perfectionist? | Match with |
| | opposite |
| 5. You have a great memory for details? | Match with |
| | same |
| 6. When managing others you lead by example? | Match with |
| | same |
| 7. You have great skill in empowering others to | Match with |
| succeed? | opposite |
| 8. You are considered very patient and reserved? | Match with |
| | opposite |
| 9. You are considered strong willed and persuade others | Match with |
| easily? | opposite |
| 10. You are creative and artistic and easily come up | Match with |
| with great ideas? | opposite |

At process block 212, the server 110 stores user generated data in the business associate database 124 or other like database.

A business summary section allows for the entry of a user defined business summary, which may include the concept of the business. The concept of the business may include without limitation what it does, products and/or services offered, and the markets served.

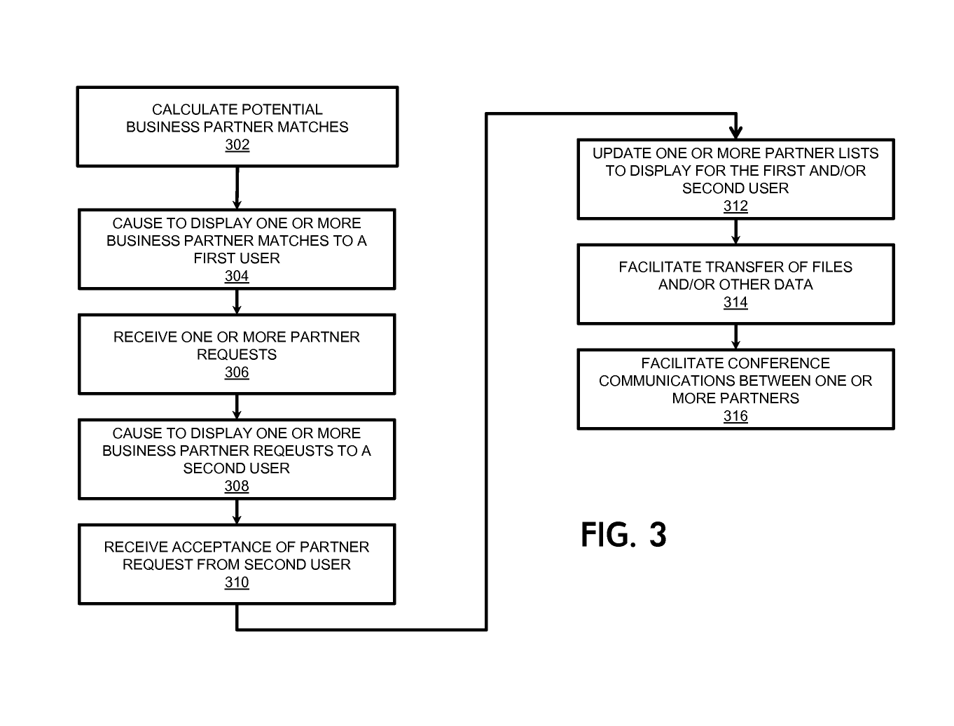

Referring now to FIG. 3, the relationship engine 116 determines business partner matches for one or more partners based on information stored in the business associate database 124 or otherwise provided by the users. In an embodiment, a score is provided and/or calculated for various combinations of users. A high score relating to at least two users indicates a potential for a successful business relationship. In some embodiments, various user responses are used to create weighted values for determining the total score of a particular potential business partners match between users. To this extent, the score may be based on ratio, average, total, or other calculation between a first user and one or more other users.

For example:
Total of fifteen (15) matching answers, where matching answers could include either of the same responses or differing responses to questions, being the highest number of matches at any other user in the geographic area, thereby resulting in the highest score and first suggested business partner/user displayed to the first user.
Total of fifteen (14) matching answers, where matching answers could include either of the same responses or differing responses to questions, being the highest number of matches at any other user in the geographic area, thereby resulting in the second highest score and second suggested business partner/user displayed to the first user.

In an embodiment, the relationship engine 116 calculates one or more business matches from a pool of users. At process block 302, the relationship engine 116 determines through mathematical calculation potential business partner matches for one or more users.

As is illustrated in matching process Table 3 below, the user provided information is evaluated for algorithmic matching of potential business partners.

TABLE 3

| | | | | | | Skill Set | Personality | Personality | |
|---|---|---|---|---|---|---|---|---|---|
| | | | | | | Question 1 | Question 1 | Question 3 | |
| | Type of | Desired | Geographic | Industry | | (Match with | (Match with | (Match with | Financial |
| User # | User | Partner | Location | Sector | Basic Info | opposite) | opposite) | same) | Info |
| 1 | Business | Investor | San | Medical | Technical | Yes | Yes | Answer A | $500K |
| | Owner | | Francisco | | | | | | Revenue |
| 2 | Entrepreneur | Entrepreneur | Miami | Engineering | Technical | No | Yes | Answer B | $100K |
| | | | | | | | | | Salary |
| 3 | Investor | Business | San | Medical | Financial | Yes | Yes | Answer B | Equity |
| | | Owner | Francisco | | | | | | |
| 4 | Service | Investor | Detroit | Financial | Management | No | No | Answer A | $1M |
| | Provider | | | | | | | | Sales |
| 5 | Business | Entrepreneur | New York | Product | All | Yes | No | Answer A | $2M |
| | Owner | | City | Development | | | | | Revenue |

In an embodiment, the relationship engine 116 performs algorithmic calculation or other matching for paring one or more potential business partners based on user supplied data, as exemplified in Table 3. For an example, the relationship engine 116 may calculate a match based on a user's desired business partner type. For another example, the relationship engine 116 may calculate a potential business partner match based on a potential business partner's geographic location in relation to the user being matched. For another example, the relationship engine 116 may calculate a potential business partner match based upon the industry sector of the user and the potential business partners. For another example, the relationship engine 116 may calculate a potential business partner match based upon basic information provided by the user. For yet another example, the relationship engine 116 may calculate a potential business partner match based upon one or more skill set related answers. The relationship engine 116 matches a user with a potential business partner that answered a skill set question with optionally with either the same or opposite answers to one or more skill set related questions. The relationship engine 116 matches a user with a potential business partner that answered a personality related question optionally with either the same or opposite answers to one or more personality questions. In some instances, the relationship engine 116 will dynamically determine whether a particular question will cause a user match with another user having provided the same answer or opposite answer.

In some instances, the relationship engine 116 will dynamically determine whether a particular question will cause a particular associated value depending on other answers. For example, a first personality answer of one user matched with a same personality answer of another user may cause the relationship engine to positivity associate a score matched with opposite answers for one or more users. For another example, the combination of a first and second personality answer for a user may cause the relationship engine 116 to match a user with an opposite answer for a third personality question.

In an embodiment, the relationship engine 116 performs a skill set matching process. The skill set matching process will match one or more users with users having unique or additional skill sets to provide the potential business match with the greatest likelihood of having the necessary skill sets to succeed in a business relationship.

In an embodiment, the relationship engine 116 generates matches based on a highest percentage of match, which may be purely formed from empirical data.

In an embodiment, the relationship engine 116 generates one or more matches of one or more users based on a combination of empirical data and statistical modeling.

In an embodiment, the relationship engine 116 places a value on corresponding coinciding responses and corresponding differing responses. A combined higher value may indicate likelihood for a more successful match. In some embodiment, some responses that coincide may receive a positive and/or higher value, whereas other responses having differing responses may receive a positive and/or higher value. For example, in some cases the relationship engine 116 may consider a differing response to a particular profile question as creating a greater likelihood of a successful business relationship between one or more partners and/or a successful business in terms of profits, growth, or other like factors in gauging a business's success. Whereas in another example, the relationship engine 116 may consider a coinciding response to a particular profile question as creating a greater likelihood of a successful business relationship between one or more partners and/or a successful business in terms of profits, growth, or other like factors in gauging a business's success.

In some embodiments, the relationship engine may place a particular value on a particular coinciding and/or differing answer based upon the answer to one or more other profile question answers, creating a dynamic matching of business partners. In some embodiments, the user sets the value of a particular response that is calculated by the relationship engine 116.

At process block 304, the client system 130 receives information for displaying one or more business partner matches to a first user. In some embodiments, the system 100 will provide a list of potential business partner matches based on mathematical calculation of user profile entries. In some embodiments, the system 100 will provide a plurality of potential business partner groupings, wherein at least one or more of the business partner groupings include two or more potential business partners.

At process block 306, the system 100 receives one or more partner requests from a first user for connecting with one or more other users. In some embodiments, the one or more partner requests includes a request for partnership of all of the users in the suggested partner grouping, the request for partnership of the members of the suggested partner grouping may be initiated via a single user initiated request.

At process block 308, the system 100 causes the display of one or more business partner requests to one or more other users. At process block 310, the system 100 receives from the one or more other users indication of acceptance of partner request.

At process block 312, the system 100 updates one or more partner lists to display for the first and/or second user.

At process block 314, the system 100 facilitates transfer of files and/or other data for communicating, including the communication of information needed for the users to determine whether they want to enter a business relationship with the other users. In some embodiments, the system 100 facilitates the transfer of business plans or other files.

In some embodiments, the system 100 maintains a list of accepted partners. In some embodiments, the system 100 may suggest potential business opportunities based on related partners.

At process block 316, the system 100 facilitates video conferencing of two or more partner matches creating a forum for introducing business concepts between two or more potential business partner matches.

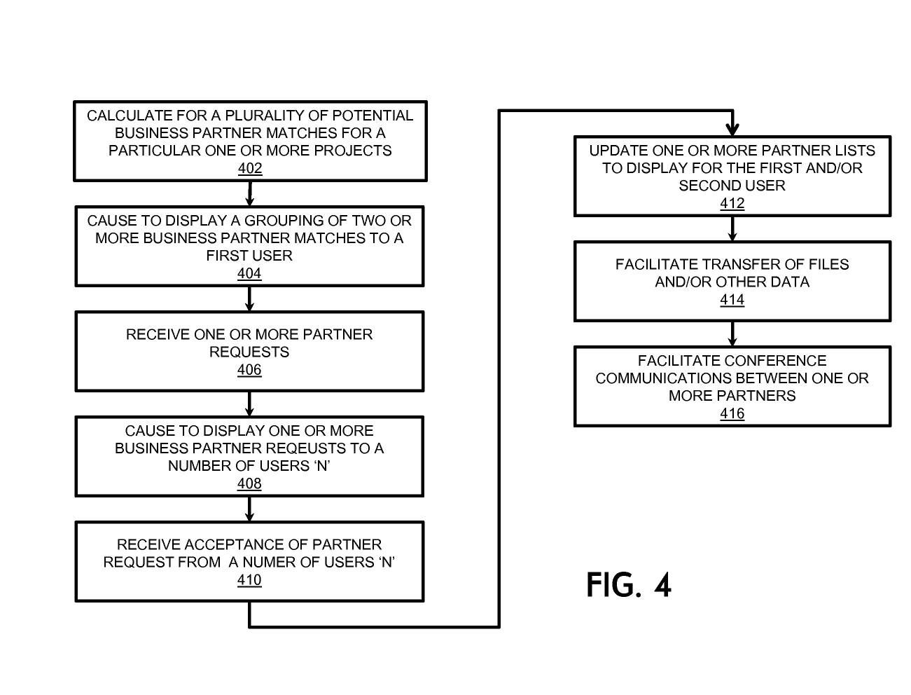

Referring now to FIG. 4, the relationship engine 116 determines business partner matches for group having at least three or more partners, the system 100 produces matches and/or recommends partnerships based on information stored in the business associate database 124. At process block 402, the system 100 calculates for a plurality of potential business partner matches for one or more projects. At process block 404, the system 100 causes to display on one or more client systems 130 one or more recommended partner groupings where at least one of the recommended partner groupings has at least two or more recommended business partner matches for a particular project. At process block 406, the system 100 receives one or more partner requests based on the one or more recommended partner groupings. At process block 408, the system 100 causes to display one or more business partner requests to two or more recommended business partners on a plurality of client systems 130. At process block 410, the system 100 receives user acceptance of partner requests from one or more recommended partners in the grouping. If one or more of the partners reject one or more of the other partners, the system 100 may substitute one or more recommended partners in the grouping based on mathematical calculation and based on other user profile responses to personality related information. At process block 412, the system 100 updates one or more partner lists to be displayed to the user that accepted a recommended user for partnership. In block 414, the system 100 facilitates transfer of files and/or other data within the spirit and scope of the instant invention. In block 416, the system 100 facilitates conference communications between the members of the recommended partnership grouping.

In some embodiments, business partnership recommendations for a particular project is mathematically analyzed and calculated by the system 100, providing positive values based on corresponding user responses for particular inquiries as well as for differing user responses for particular inquiries. The corresponding and/or differing user responses may relate to a number of criteria, which may optionally include without limitation any or all of the particular type of project, personality related responses of the users, the skills of the existing businesses, the financial strength of the businesses, the business location or locations, the number of locations, the skills of the users, and the number of previously successful partnerships. In some embodiments, the system 100 may receive responses from users regarding the outcome of previous partners and such received information may be used for determining future business partnerships.

In some embodiments, the system 100 generates partnership matches based not on the satisfaction of the potential partners, but instead on the likelihood that the potential partners are business comparable and/or likely to generate a desired income or other measurable business result.

While the instant invention discusses the implementation of a relationship engine 116, business associate database 124, and other system and server components, other like systems and methods that are implemented to arrive at the instant one or more embodiments or function contained herein are within the spirit and scope of the instant invention.

As used herein, when the term “and/or” is used, it shall include all combinations of one or more of the associated described items.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are contemplated in light of the above teachings without departing from the scope and spirit of the invention. It will be readily apparent that various changes may be made thereto without departing from the spirit and scope of the disclosure or sacrificing all of its material advantages. The examples and embodiments described herein are merely exemplary of the instant disclosure.

What is claimed is:

1. A method for identifying suggested business partners performed in a non-transitory computer readable medium, the method comprising:
receiving personality information relating to a plurality of potential business partners;
receiving skill set information relating to a plurality of potential business partners; and
determining, based on at least one of the personality information and the skill set information, a relative strength of potential business relationship partnership between a first user and a second user.

2. The method of claim 1 further comprising receiving business information relating to a plurality of potential business partners, wherein the business information is used in determining the relative strength of potential business relationship partnership between the first user and the second user.

3. The method of claim 1 further comprising receiving financial information relating to a plurality of potential business partners, wherein the financial information is used in determining the relative strength of potential business relationship partnership between the first user and the second user.

4. The method of claim 1 further comprising displaying to a plurality of users at least one potential business partner.

5. The method of claim 1 further comprising associating a greater value between a first user and a second user having coinciding responses to a personality question.

6. The method of claim 1 further comprising associating a greater value between a first user and a second user having differing responses to a personality question.

7. The method of claim 1 further comprising associating a greater value between a first user and a second user having coinciding response to a personality question.

8. A method for calculating business partner relationship strength between a plurality of users performed in a non-transitory computer readable medium, the method comprising:
calculating a projected business partner strength score between a first user and at least a second user based on response data for determining a likelihood of a successful business partnership with at least a second user; and
suggesting to the first user potential business partnerships with at least the second user.

9. The method of claim 8 wherein the response data includes personality response data of the first user and at least the second user.

10. The method of claim 9 further comprising assessing an increased business partner strength score resulting from a personality question response of the first user differing with a personality question response of the second user.

11. The method of claim 9 further comprising assessing an increased business partner strength score resulting from a personality question response of the first user coinciding with a personality question response of the second user.

12. The method of claim 10 further comprising facilitating communication between the first user and the second user.

13. The method of claim 8 further comprising calculating the projected business partner strength score based on a plurality of user ratings.

14. The method of claim 8 further comprising calculating the projected business partner strength score based on a plurality of user ratings.

15. The method of claim 14 further comprising calculating the projected business partner strength score based on success of prior partnerships of at least the second user.

16. The method of claim 8 further comprising displaying to the first user potential business partnership opportunities with at least the second user having at least one of a corresponding personality response and at least one of a differing personality response.

17. A method for matching potential business partners performed in a non-transitory computer readable medium, the method comprising:
receiving information from a first user related to a particular business venture;
matching a second user to the particular business venture based on a combination of desired business venture data from the second user, skill set response data from the second user, personality response data from the second user, and financial information data from the second user.

18. The method of claim 17 further comprising:
determining a likelihood of a successful business partnership match based on:
an associated value for the personality response data from the second user; and
an associated value for the skill set response data from the second user; and
suggesting the second user to the first user as a potential business partner.
